(19) United States
(12) Patent Application Publication
(10) Pub. No.: US 2010/0052285 A1
(43) Pub. Date: Mar. 4, 2010

(54) Integral Bicycle Frame

(75) Inventors: Davis Wang, Taichung County (TW); Arthur Fan, Hsinchu County (TW)

Correspondence Address: THE MUELLER LAW OFFICE, P.C., 12951 Harwick Lane, San Diego, CA, 92130, US

(73) Assignee: Composite Technology Corporation, Taichung Hsien (TW)

(21) Appl. No.: 12/370,550

(22) Filed: Feb. 12, 2009

(30) Foreign Application Priority Data
Aug. 29, 2008 (TW) 097133250

(51) Int. Cl. B62K 3/02

(52) U.S. Cl. 280/281.1

(57) ABSTRACT

An integral bicycle frame includes a single-piece molded front frame unit with first and second joined regions, and a single-piece molded rear frame unit with upper and lower anchored regions which are respectively coupled with the first and second joined regions through upper and lower coupling joints. Each of the upper and lower coupling joints has a tubular socket blank and a plug blank which respectively have inner and outer tubular surfaces matingly fitted to each other. The inner and outer tubular surfaces of one of the coupling joints are configured to respectively diverge and converge toward each other so as to facilitate inter-engagement therebetween.

### CROSS-REFERENCE TO RELATED APPLICATION

This application claims priority of Taiwanese Patent Application No. 097133250, filed on Aug. 29, 2008, the disclosure of which is herein incorporated by reference.

### BACKGROUND OF THE INVENTION

1. Field of the Invention

This invention relates to an integral bicycle frame, more particularly to an integral bicycle frame with two frame units coupled to each other through two coupling joints.

2. Description of the Related Art

A conventional bicycle frame generally includes a head tube, top and bottom tubes, and a seat tube which are connected to each other by three to six joints. As such, the conventional bicycle frame has the disadvantage of unsteady structure and increased assembling time and cost. Referring to FIGS. 1 and 2, an integral bicycle frame 1 disclosed in Taiwanese Utility Model No. M317982 includes a front frame unit 11 and a seat tube 12 which are molded individually and which are made from a carbon fiber reinforced polymer. The front frame unit 11 includes top and bottom tubes which extend rearwardly to terminate at upper and lower ends 111, 112, respectively. The upper end 111 is of a concave shape and abuts against an outer surface of the seat tube 12. The lower end 112 is in the form of a socket. The seat tube 12 is formed with a plug 121 which is inserted into the socket 112 to connect the seat tube 12 to the front frame unit 11. Although the bicycle frame 1 can be manufactured relatively easily using comparatively small molds and although the length of the seat tube 12 can be varied to suit different dimensions of the front frame unit 11 by virtue of the abutting engagement between the upper end 111 and the seat tube 12, there remains the problem of unsteady structure at the joint.

### SUMMARY OF THE INVENTION

An object of the present invention is to provide an integral bicycle frame with a robust and steady structure.

According to this invention, the integral bicycle frame includes a single-piece molded front frame unit, a single-piece molded rear frame unit, and upper and lower coupling joints. The front frame unit includes a front junction, an upper tube extending rearwardly from the front junction along an upper axis to terminate at a first joined region, and a lower tube extending rearwardly and downwardly from the front junction along a lower axis to terminate at a second joined region. The rear frame unit includes a rear tube which extends in a lengthwise direction to terminate at upper and lower ends, and upper and lower tubular mounts respectively extending from the upper and lower ends along the upper and lower axes, respectively, and respectively terminating at upper and lower anchored regions. The upper and lower coupling joints are disposed to seamlessly couple the upper and lower anchored regions to the first and second joined regions, respectively. The upper and lower coupling joints are made by a process which includes the steps of:

(a) providing a first tubular socket blank integrally formed with the upper anchored region, and a first plug blank integrally formed with the first joined region, the first tubular socket blank and the first plug blank respectively having first inner and outer tubular surfaces that are configured to respectively diverge and converge toward each other so as to be matingly fitted to each other along the upper axis, and

providing a second tubular socket blank integrally formed with the second joined region, and a second plug blank integrally formed with the lower anchored region, the second tubular socket blank and the second plug blank respectively having second inner and outer tubular surfaces that are matingly fitted to each other along the lower axis; and

(b) applying a resinous adhesive between the first inner and outer tubular surfaces, and between the second inner and outer tubular surfaces so as to form the upper and lower coupling joints.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic exploded side view of a conventional integral bicycle frame;

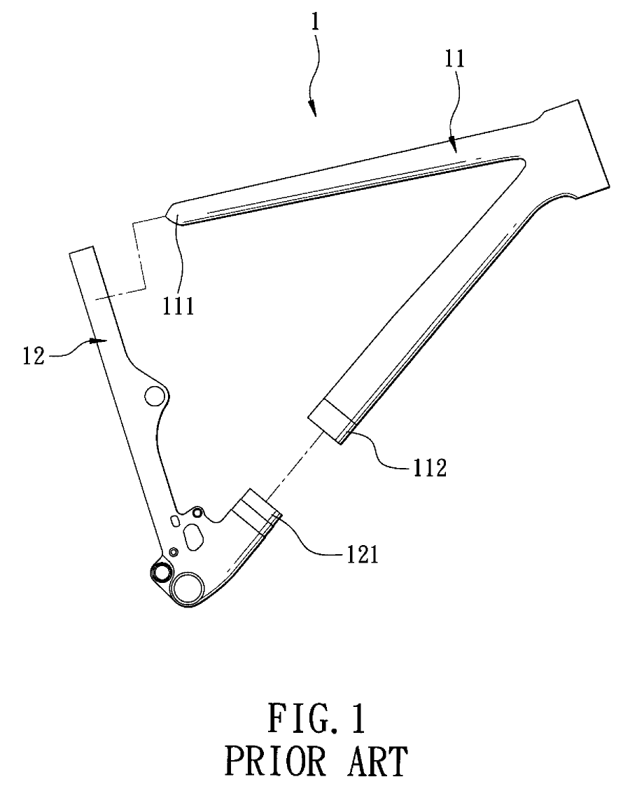

FIG. 2 is a schematic side view of the conventional integral bicycle frame;

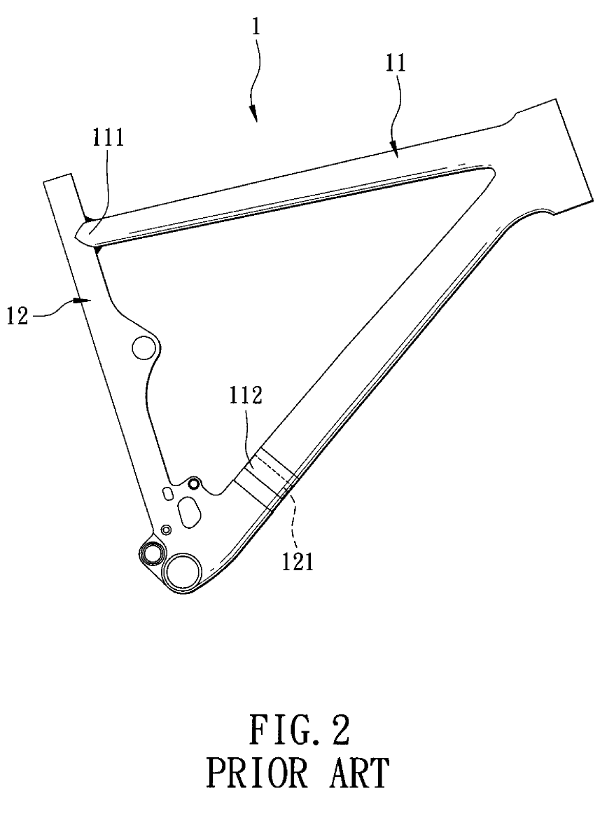

FIG. 3 is a schematic exploded side view of the preferred embodiment of an integral bicycle frame according to this invention;

FIG. 4 is a schematic side view of the preferred embodiment, showing a front frame unit connected to a rear frame unit;

FIG. 5 is a fragmentary sectional view of an upper coupling joint of the preferred embodiment; and

FIG. 6 is a fragmentary sectional view of a lower coupling joint of the preferred embodiment.

### DETAILED DESCRIPTION OF THE PREFERRED EMBODIMENT

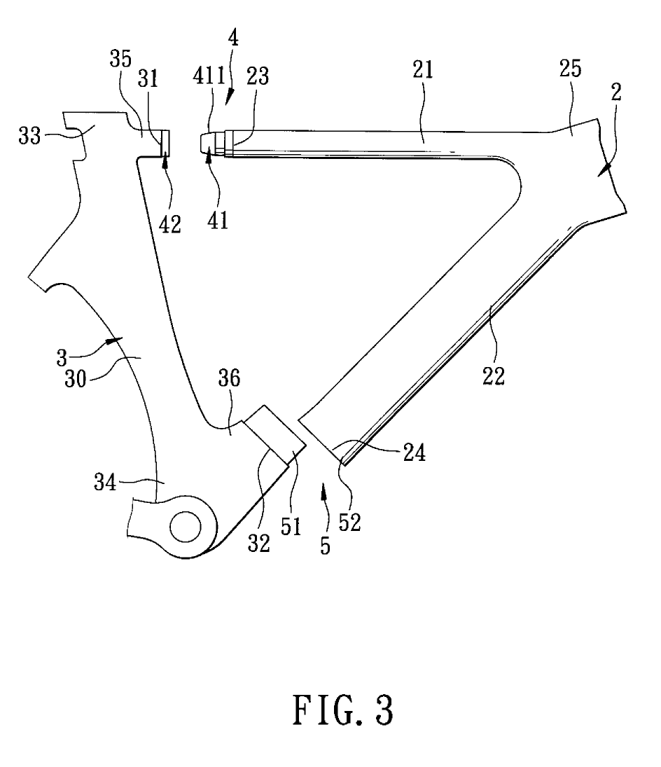

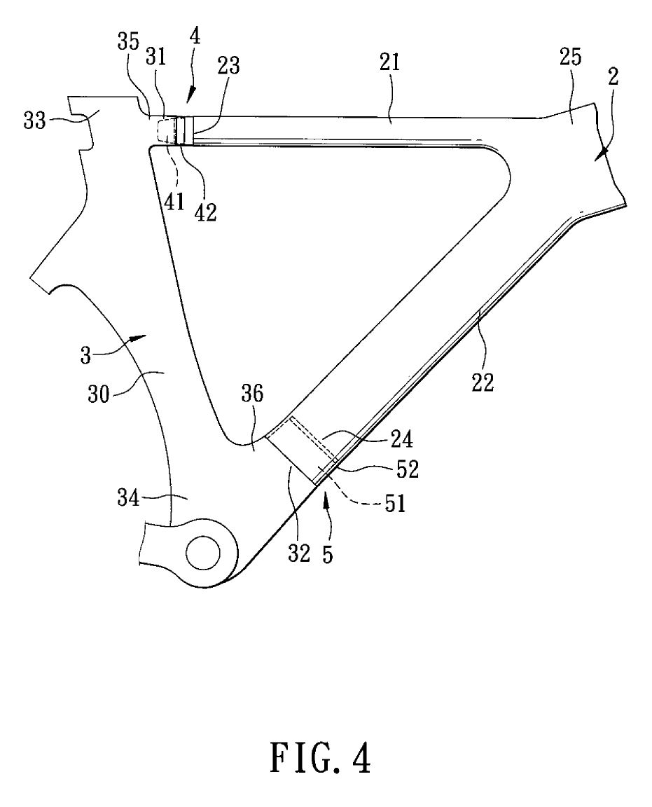

Referring to FIGS. 3 and 4, the preferred embodiment of an integral bicycle frame according to the present invention is shown to comprise a front frame unit 2, a rear frame unit 3, and upper and lower coupling joints 4, 5. The front and rear frame units 2, 3 are molded into single pieces using individual molds and are made from a carbon fiber reinforced polymer.

The single-piece molded front frame unit 2 includes a front junction 25 which is adapted to be connected to a head tube (not shown), an upper tube 21 which extends rearwardly from the front junction 25 along an upper axis to terminate at a first joined region 23, and a lower tube 22 which extends rearwardly and downwardly from the front junction 25 along a lower axis to terminate at a second joined region 24. In this embodiment, the upper and lower tubes 21, 22 serve as top and bottom tubes of the integral bicycle frame.

The single-piece molded rear frame unit 3 includes a rear tube 30 which extends in a lengthwise direction to terminate at upper and lower ends 33, 34, an upper tubular mount 35 which is integrally formed with and which extends from the upper end 33 along the upper axis and which terminates at an upper anchored region 31, and a lower tubular mount 36 which is integrally formed with and which extends from the lower end 34 along the lower axis and which terminates at a lower anchored region 32. In this embodiment, the rear tube 30 serves as a seat tube. The upper and lower coupling joints 4, 5 are disposed to seamlessly couple the upper and lower anchored regions 31, 32 to the first and second joined regions 23, 24, respectively. The upper and lower coupling joints 4, 5 are made by a process which includes the following steps.

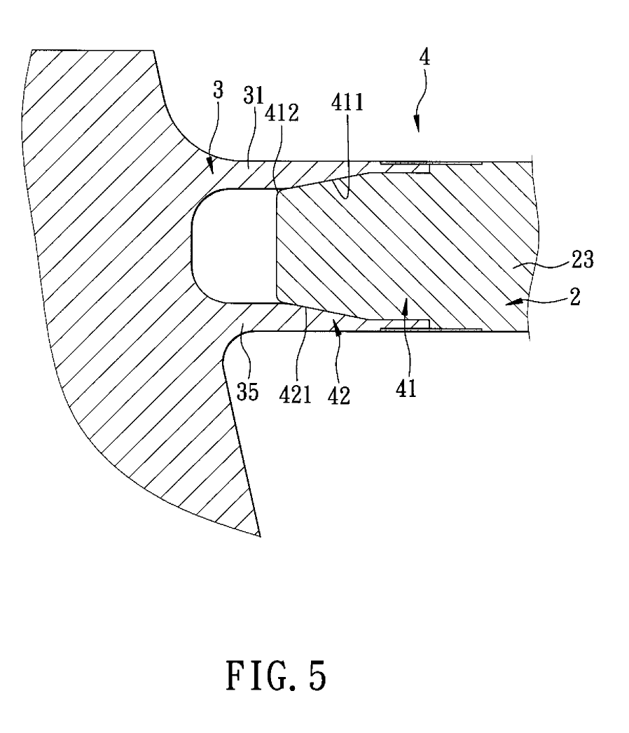

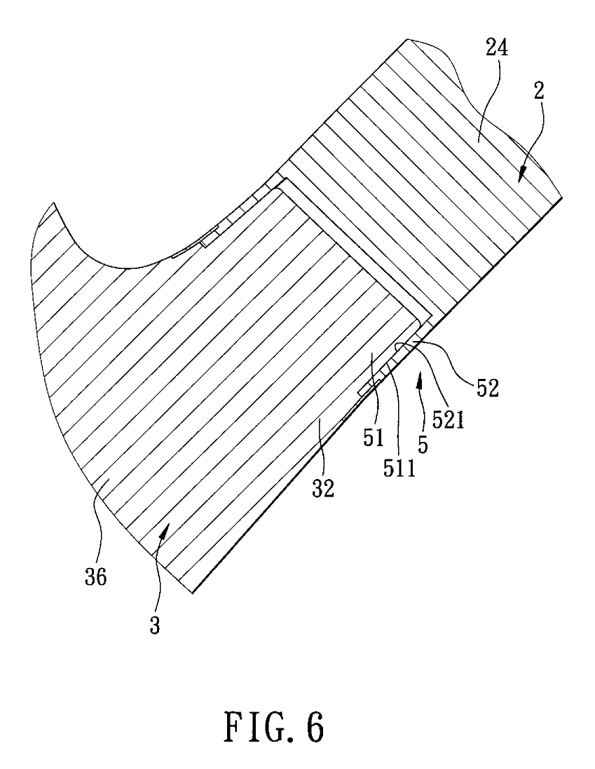

In step (a), a first tubular socket blank 42 and a first plug blank 41 are provided. The first tubular socket blank 42 is integrally formed with the upper anchored region 31. The first plug blank 41 is integrally formed with the first joined region 23. The first tubular socket blank 42 and the first plug blank 41 are separately molded, and are formed integrally and respectively with the upper anchored region 31 and the first joined region 23 using the carbon fiber reinforced polymer. In this embodiment, as shown in FIG. 5, the first tubular socket blank 42 and the first plug blank 41 respectively have first inner and outer tubular surfaces 421, 411 which are configured to respectively diverge and converge toward each other along the upper axis so as to be matingly fitted to each other along the upper axis. Preferably, the first outer tubular surface 411 of the first plug blank 41 is configured to converge to terminate at a leading end of a reduced size so as to be spaced apart from the first inner tubular surface 421 in radial directions, thereby facilitating the fitting engagement between the first outer and inner tubular surfaces 411,421. Step (a) further includes providing a second tubular socket blank 52 which is integrally formed with the second joined region 24, and a second plug blank 51 which is integrally formed with the lower anchored region 32. The second tubular socket blank 52 and the second plug blank 51 are separately molded, and are formed integrally and respectively with the second joined region 24 and the lower anchored region 32 using the carbon fiber reinforced polymer. As shown in FIG. 6, the second tubular socket blank 52 and the second plug blank 51 respectively have second inner and outer tubular surfaces 521, 511 that are matingly fitted to each other along the lower axis.

In step (b), a resinous adhesive is applied between the first inner and outer tubular surfaces 411, 421, and between the second inner and outer tubular surfaces 521, 511 so as to form the upper and lower coupling joints 4, 5.

In step (c), each of coupled junctures between the upper anchored region 31 and the first joined region 23, and between the lower anchored region 32 and the second joined region 24 is wrapped with a sheet of resin-impregnated carbon fiber cloth.

In step (d), the resin-impregnated carbon fiber cloth is heat/air cured so as to obtain seamless coupled junctures.

Preferably, each of the first and second outer tubular surfaces 421, 511 has a length ranging from 10 mm to 60 mm. More preferably, each of the first and second outer tubular surfaces 421, 511 has a length ranging from 15 mm to 50 mm. As illustrated, since the front and rear frame units 2, 3 are formed using individual molds, the molds are relatively small and can be operated conveniently as compared with the prior art in which five tubular pieces are molded in a single mold. In addition, with the provision of the converged leading end 412, after the second plug blank 51 is partially inserted into the second tubular socket blank 52, the front frame unit 2 is forced to be slightly deformed, thereby facilitating alignment and insertion of the first plug blank 41 with and into the first tubular socket blank 42. Furthermore, by virtue of the fitting engagement between the first inner and outer tubular surfaces 411, 421 and between the second inner and outer tubular surfaces 521, 511, the upper and lower coupling joints 4, 5 have good structural strength, thereby providing the integral bicycle frame according to this invention with a steady structure. In addition, by virtue of the diverging and converging configurations of the first inner and outer tubular surfaces 411, 421, the area of engagement between the first inner and outer tubular surfaces 411, 421 is increased, i.e., the surface areas for application of the resinous adhesive are increased, thereby strengthening the bonding effect.

It is noted that the arrangement described above can be varied. For example, the first tubular socket blank 42 may be formed with the first joined region 23, and the first plug blank 41 may be formed with the upper anchored region 31. The second tubular socket blank 52 may be formed with the lower anchored region 32, and the second plug blank 51 may be formed with the second joined region 24. The second inner and outer tubular surfaces 521, 511 of the second tubular socket blank 52 and the second plug blank 51 may be configured to diverge and converge toward each other along the lower axis.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. An integral bicycle frame comprising:
a single-piece molded front frame unit which includes a front junction, an upper tube that extends rearwardly from said front junction along an upper axis to terminate at a first joined region, and a lower tube that extends rearwardly and downwardly from said front junction along a lower axis to terminate at a second joined region;
a single-piece molded rear frame unit including a rear tube which extends in a lengthwise direction to terminate at upper and lower ends, and upper and lower tubular mounts which respectively extend from said upper and lower ends along the upper and lower axes, respectively, and which respectively terminate at upper and lower anchored regions; and
upper and lower coupling joints disposed to seamlessly couple said upper and lower anchored regions to said first and second joined regions, respectively, said upper and lower coupling joints being made by a process which includes the steps of:
(a) providing a first tubular socket blank integrally formed with one of said upper anchored region and said first joined region, and a first plug blank integrally formed with the other one of said upper anchored region and said first joined region, said first tubular socket blank and said first plug blank being separately molded and respectively having first inner and outer tubular surfaces that are matingly fitted to each other along the upper axis, and
providing a second tubular socket blank integrally formed with one of said lower anchored region and said second joined region, and a second plug blank integrally formed with the other one of said lower anchored region and said second joined region, said second tubular socket blank and said second plug blank being separately molded and respectively having second inner and outer tubular surfaces that are matingly fitted to each other along the lower axis,
at least one of said first and second inner tubular surfaces and a corresponding one of said first and second outer tubular surfaces being configured to respectively diverge and converge toward each other along a respective one of the upper and lower axes; and
(b) applying a resinous adhesive between said first inner and outer tubular surfaces, and between said second inner and outer tubular surfaces so as to form said upper and lower coupling joints.

2. The integral bicycle frame according to claim 1, wherein said front and rear frame units, said first and second tubular socket blanks, and said first and second plug blanks are made from a carbon fiber reinforced polymer.

3. The integral bicycle frame according to claim 1, wherein said front junction of said front frame unit is adapted to be connected to a head tube, and said rear tube serves as a seat tube.

4. The integral bicycle frame according to claim 1, wherein said first inner tubular surface of said first tubular socket blank is configured to diverge along the upper axis from said one of said upper anchored region and said first joined region, and said first outer tubular surface of said first plug blank is configured to converge along the upper axis from said other one of said upper anchored region and said first joined region.

5. The integral bicycle frame according to claim 4, wherein said first outer tubular surface of said first plug blank is configured to converge to terminate at a leading end of a reduced size so as to be spaced apart from said first inner tubular surface in radial directions, thereby facilitating fitting engagement between said first outer and inner tubular surfaces.

6. The integral bicycle frame according to claim 4, wherein each of said first and second outer tubular surfaces has a length ranging from 10 mm to 60 mm.

7. The integral bicycle frame according to claim 4, wherein each of said first and second outer tubular surfaces has a length ranging from 15 mm to 50 mm.

8. The integral bicycle frame according to claim 1, wherein said process further includes a step of wrapping each of coupled junctures between said upper anchored region and said first joined region, and between said lower anchored region and said second joined region with a sheet of resin-impregnated carbon fiber cloth.

9. The integral bicycle frame according to claim 8, wherein said process further includes a step of heat/air curing the resin-impregnated carbon fiber cloth so as to obtain seamless coupled junctures.
